(19) United States
(12) Patent Application Publication
(10) Pub. No.: US 2008/0132609 A1
(43) Pub. Date: Jun. 5, 2008

(54) Fiber-Reinforced U-PVC foam materials and methods of preparing and use thereof

(76) Inventors: Qing Shui, Cranston, RI (US); Dongbo Chen, Lexington, MA (US); Hao Shui, Shanghai (CN); Xi-qi Zhang, Shanghai (CN)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(21) Appl. No.: 11/983,219

(22) Filed: Nov. 7, 2007

(30) Foreign Application Priority Data
Nov. 7, 2006 (CN) 200610118032

(51) Int. Cl. C08L 97/02

(52) U.S. Cl. 524/9

(57) ABSTRACT

This present teachings relate to compositions that can include U-PVCs and flax fibers, and methods of preparing and use the same. Comparing to the existing technology, this invention has the advantages of producing materials that can be light weight, high strength, good aesthetic appearance, high machinability, high resistance to wear, abrasion, grease, and/or aging, non-toxic, low odor, and easy to clean.

### CROSS REFERENCE TO RELATED APPLICATION

This application claims priority to and the benefit of Chinese Patent Application Serial No. 200610118032, filed on Nov. 7, 2006, the disclosure of which is incorporated by reference in its entirety.

### BACKGROUND

During the past decades, mechanical properties of un-plasticized polyvinyl chloride (“U-PVC,” also known as rigid PVC) have been greatly improved largely due to development in formulation and processing. As a result, U-PVC has been widely used, for example, in the construction industry. However, because of its high density, low tensile strength and low aesthetic appearance, U-PVC is not a material of choice for wood replacement. Modified U-PVC materials, including U-PVC foam materials and wood-plastics composite materials, albeit with better properties, still need improvement because of their low strength and low aging resistance.

Accordingly, the art desires new light-weight materials that can have high strength, good aesthetic appearance, and good aging resistance.

### SUMMARY

It now has been discovered that materials including fiber-reinforced U-PVC foam compositions can address various deficiencies and shortcomings of the prior art including those outlined above. The present teachings relate to such compositions as well as methods of preparing and using such compositions.

In one aspect, the present teachings provide compositions that generally include U-PVCs and flax fibers. In certain embodiments, the compositions can include fiber-reinforced U-PVC foam compositions. In some embodiments, the compositions can include blends from which the fiber-reinforced U-PVC foam compositions can be prepared.

In another aspect, the present teachings provide methods of preparing the fiber-reinforced U-PVC foam compositions. In some embodiments, the methods can include processing the blends to provide the fiber-reinforced U-PVC foam compositions.

The present teachings also provide various composites, articles of manufacture, and structures that include the fiber-reinforced U-PVC foam compositions disclosed herein.

The foregoing, and other features and advantages of the present teachings will be more fully understood from the following description, examples, and claims.

### DETAILED DESCRIPTION

Throughout the description, where compositions are described as having, including, or comprising specific components, or where processes are described as having, including, or comprising specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components and can be selected from a group consisting of two or more of the recited elements or components. It is anticipated that one or more members of a group can be included in, or deleted from, a group for reasons of convenience and/or patentability. For example, it should be understood that elements and/or features of a composition, an apparatus, or a method described herein can be combined in a variety of ways without departing from the spirit and scope of the present teachings, whether explicit or implicit herein. When any such inclusion or deletion occurs, the specification is herein deemed to contain the group as modified thus fulfilling the written description of all Markush groups used in the appended embodiments.

The use of the terms “include,” “includes,” “including,” “have,” “has,” and “having” should be understood generally as open-ended and non-limiting unless specifically stated otherwise. The use of any and all examples or exemplary language (e.g., “such as”) herein is intended merely to illuminate better the invention and does not pose a limitation on the scope of the invention otherwise described or claimed. No language in the specification should be construed as indicating any non-claimed element essential to the practice of the invention.

The use of the singular herein includes the plural (and vice versa) unless specifically stated otherwise or clearly contradicted by the context. In addition, where the use of the term “about” is before a quantitative value, the present teachings also include the specific quantitative value itself, unless specifically stated otherwise. As used herein, the term “about” refers to a ±10% variation from the nominal value.

It should be understood that the order of steps or order for performing certain actions is immaterial so long as the present teachings remain operable. Moreover, two or more steps or actions can be conducted simultaneously.

At various places in the present specification, temperatures or amounts are disclosed in groups or in ranges. It is specifically intended that the description include each and every individual subcombination of the members of such groups and ranges.

In one aspect, the present teachings provide compositions that can include U-PVCs and flax fibers. In certain embodiments, the compositions can be fiber-reinforced U-PVC foam compositions. In some embodiments, the compositions can be blends from which the fiber-reinforced U-PVC foam compositions can be prepared.

In some embodiments, the fiber-reinforced U-PVC foam compositions can include U-PVCs and flax fibers. In some embodiments, the fiber-reinforced U-PVC foam compositions can further include additives. Examples of such additives include stabilizers, lubricants, processing aids, pigments, and combinations thereof.

In some embodiments, the fiber reinforced U-PVC foam compositions can further include gaseous components or void volumes that can result from the foaming agents in the blend. Examples of gaseous components include air, nitrogen gas, carbon dioxide gas, perfluorocarbons, and combinations thereof.

In certain embodiments, the fiber-reinforced U-PVC compositions can include U-PVCs, flax fibers, stabilizers, lubricants, processing aids, and gaseous components.

In various embodiments, the blends include U-PVCs and flax fibers. In some embodiments, the blends can further include additives. Examples of the additives include stabilizers, lubricants, foaming agents, processing aids, pigments, and combinations thereof. In certain embodiments, the blends can include U-PVCs, flax fibers, stabilizers, lubricants, foaming agents, processing aids, and pigments.

In some embodiments of the fiber-reinforced U-PVC foam compositions or the blends, the U-PVCs can be present in an amount no less than about 5 wt %. In certain embodiments, the amount of the U-PVCs can be between about 10 wt % and about 99 wt %, for example, between about 20 wt % and about 95 wt %, between about 30 wt % and about 95 wt %, between about 40 wt % and about 95 wt %, between about 50 wt % and about 95 wt %, between about 60 wt % and about 95 wt %, between about 20 wt % and about 90 wt %, between about 30 wt % and about 90 wt %, between about 40 wt % and about 90 wt %, between about 50 wt % and about 90 wt %, between about 60 wt % and about 90 wt %, between about 20 wt % and about 85 wt %, between about 30 wt % and about 85 wt %, between about 40 wt % and about 85 wt %, between about 50 wt % and about 85 wt %, between about 60 wt % and about 85 wt %, or between about 65 wt % and about 80 wt %.

In some embodiments of the fiber-reinforced U-PVC foam compositions or the blends, the flax fibers can be present in an amount no less than about 1 wt %. In certain embodiments, the amount of the flax fibers can be between about 1 wt % and about 90 wt %, for example, between about 1 wt % and about 80 wt %, between about 1 wt % and about 70 wt %, between about 1 wt % and about 60 wt %, between about 1 wt % and about 50 wt %, between about 1 wt % and about 40 wt %, between about 1 wt % and about 30 wt %, between about 1 wt % and about 20 wt %, between about 5 wt % and about 50 wt %, between about 5 wt % and about 40 wt %, between about 5 wt % and about 30 wt %, and between about 5 wt % and about 20 wt %.

In some embodiments of the fiber-reinforced U-PVC foam compositions or the blends, the stabilizers can be non-toxic. For example, the non-toxic stabilizers can be non-toxic complex stabilizers. In certain embodiments, the stabilizers can include calcium stabilizers, including calcium salts and soaps; zinc stabilizers, including zinc salts and soaps; magnesium stabilizers, including magnesium salts and soaps; barium stabilizers, including barium salts and soaps; cadmium stabilizers, including cadmium salts and soaps; tin stabilizers, including tin salts and organo-tin compounds; antimony stabilizers, including antimony salts and organo-antimony compounds; fatty esters; organic phosphite esters; epoxides; and polyols. For example, the stabilizers can include calcium stabilizers and zinc stabilizers. In particular embodiments, the stabilizers can be calcium-zinc complex stabilizers.

In some embodiments of the fiber-reinforced U-PVC foam compositions or the blends, the stabilizers can be present in an amount no less than about 1 wt %. In certain embodiments, the amount of the stabilizers can be between about 1 wt % and about 50 wt %. For example, the amount of the stabilizers can be between about 1 wt % and about 40 wt %, between about 1 wt % and about 30 wt %, between about 1 wt % and about 20 wt %, between about 1 wt % and about 10 wt %, between about 2 wt % and about 50 wt %, between about 2 wt % and about 40 wt %, between about 2 wt % and about 30 wt %, between about 2 wt % and about 20 wt %, or between about 2 wt % and about 10 wt %. In particular embodiments, the amount of the stabilizers can be about 5 wt %.

In some embodiments of the fiber-reinforced U-PVC foam compositions or the blends, the lubricants can include fatty acids (e.g., stearic acids), fatty alcohols, fatty esters, fatty amides, fatty acid salts (e.g., stearates), waxes (e.g., paraffin waxes and polyethylene waxes), silicone lubricants, and fluorocarbon lubricants. In particular embodiments, the lubricants can be polyethylene waxes, stearic acid, and/or stearate salts.

In some embodiments of the fiber-reinforced U-PVC foam compositions or the blends, the lubricants can be present in an amount no less than about 1 wt %. In certain embodiments, the amount of the lubricants can be between about 1 wt % and about 50 wt %. For example, the amount of the lubricants can be between about 1 wt % and about 40 wt %, between about 1 wt % and about 30 wt %, between about 1 wt % and about 20 wt %, between about 1 wt % and about 10 wt %, between about 2 wt % and about 50 wt %, between about 2 wt % and about 40 wt %, between about 2 wt % and about 30 wt %, between about 2 wt % and about 20 wt %, between about 2 wt % and about 10 wt %, or between about 2 wt % and about 6 wt %. In particular embodiments, the amount of the lubricants can be about 5 wt %.

In various embodiments, the fiber-reinforced U-PVC foam compositions or the blends can further include processing aids that can accelerate the melting of PVC resin, change the fluidity of the melting body, and/or improve the surface quality of the products. In certain embodiments, the processing aids can be polyarylate copolymer processing aids.

In some embodiments of the fiber-reinforced U-PVC foam compositions or the blends, a processing aid can be present in an amount no less than about 1 wt %. In certain embodiments, the amount of the processing aid can be between about 1 wt % and about 50 wt %. For example, the amount of the processing aid can be between about 1 wt % and about 40 wt %, between about 1 wt % and about 30 wt %, between about 1 wt % and about 20 wt %, between about 1 wt % and about 10 wt %, between about 2 wt % and about 50 wt %, between about 2 wt % and about 40 wt %, between about 2 wt % and about 30 wt %, between about 2 wt % and about 20 wt %, between about 2 wt % and about 10 wt %, or between about 2 wt % and about 6 wt %. In particular embodiments, the amount of the processing aid can be about 5 wt %.

In various embodiments, the blends can further include foaming agents. Examples of foaming agents include reactive foaming agents, including azo compounds, hydrazine compounds, carbazide compounds, tetrazole compounds, nitroso compounds, carbonate compounds, and combinations thereof, and non-reactive foaming agents, including nitrogen gas, carbon dioxide gas, perfluorocarbons, and combinations thereof. In certain embodiments, the blends can include the azo compounds. Examples of the azo compounds are azodicarbonamides. In particular embodiments, the blends can include azodicarbonamide foaming agents (“AC foaming agents”).

In some embodiments, the blends can include a foaming agent in an amount no less than about 1 wt %. In certain embodiments, the amount of the foaming agent can be between about 1 wt % and about 50 wt %. For example, the amount of the foaming agent can be between about 1 wt % and about 40 wt %, between about 1 wt % and about 30 wt %, between about 1 wt % and about 20 wt %, between about 1 wt % and about 10 wt %, between about 2 wt % and about 50 wt %, between about 2 wt % and about 40 wt %, between about 2 wt % and about 30 wt %, between about 2 wt % and about 20 wt %, between about 2 wt % and about 10 wt %, or between about 2 wt % and about 6 wt %. In particular embodiments, the amount of the foaming agent can be about 5 wt %.

In another aspect, the present teachings provide methods of preparing the fiber-reinforced U-PVC foam compositions. In some embodiments, the methods can include processing the blends at an elevated temperature to provide the fiber-reinforced U-PVC foam compositions. In some embodiments, the method can further include mixing the blends. In certain embodiments, processing the blends can include compounding, extruding, injection molding, compression molding, and/or calendaring. In particular embodiments, the methods can include mixing the blends and extruding the blends to provide the fiber-reinforced U-PVC foam compositions. In certain embodiments, the methods can further include treating the surface of the composition after processing.

In various embodiments, the blends are processed at elevated temperatures (i.e., temperatures above ambient temperature). In such cases, the elevated temperature can be equal to or greater than the melting temperature of the U-PVC. In certain embodiments, the elevated temperature can be equal to or greater than 80° C. For example, the elevated temperature can be between about 80° C. and about 300° C., between about 90° C. and about 300° C., between about 100° C. and about 300° C., between about 110° C. and about 300° C., between about 120° C. and about 300° C., between about 130° C. and about 300° C., between about 140° C. and about 300° C., between about 150° C. and about 300° C., between about 160° C. and about 300° C., between about 170° C. and about 300° C., between about 180° C. and about 300° C., between about 190° C. and about 300° C., between about 200° C. and about 300° C., between about 210° C. and about 300° C., between about 220° C. and about 300° C., between about 80° C. and about 250° C., between about 80° C. and about 220° C., between about 80° C. and about 200° C., between about 80° C. and about 190° C., between about 80° C. and about 180° C., between about 80° C. and about 170° C., between about 80° C. and about 160° C., between about 80° C. and about 150° C., between about 80° C. and about 140° C., between about 80° C. and about 130° C., between about 80° C. and about 120° C., between about 80° C. and about 110° C., or between about 80° C. and about 100° C. In particular embodiments, the elevated temperature can be between about 100° C. and about 200° C. (e.g., about 100° C., about 140° C., about 190° C., or about 200° C.).

In another aspect, the present teachings provide use of the fiber-reinforced U-PVC foam compositions. In some embodiments, the use can be as a wood replacement. In certain embodiments, the use can be for construction materials, furniture materials, and/or art materials. In particular embodiments, the use of the compositions can be for decking and/or fencings.

In another aspect, the present teachings provide articles of manufacture that can include the fiber-reinforced U-PVC foam compositions. In some embodiments, the articles of manufacture can be furniture, artworks, and structures (e.g., buildings, docks, bridges, or decks). In certain embodiments, the articles of manufacture can be patio decks, boardwalks, outdoor furniture, fences, railings, shutters, and window and door frames, doors, wall frames, sidings, floors, or ceilings. In particular embodiments, the articles of manufacture can be fences, floors, or decking.

The following examples are provided to illustrate further and to facilitate the understanding of the present teachings and are not in any way intended to limit the invention.

### EXAMPLE 1

PVC resin (60 kg), flax fiber (20 kg), non-toxic calcium-zinc complex stabilizer (10 kg), AC foaming agent (5 kg), and polyethylene wax (PE wax, 5 kg) were mixed. The resulting blend was charged into an extruder and extruded at 100° C. to produce an extrudate, which was cooled and surface-treated to provide a decking board.

### EXAMPLE 2

PVC resin (85 kg), flax fiber (5 kg), non-toxic calcium-zinc complex stabilizer (2 kg), AC foaming agent (6 kg), and a polyacrylate copolymer processing aid (Zibo Huaxing Additives Co., Ltd., Zigo, Shandong, China; Catalog Number: ZB530; 2 kg) were mixed. The resulting blend was charged into an extruder and extruded at 200° C. to produce an extrudate, which was cooled and surface-treated to provide a decking board.

### EXAMPLE 3

PVC resin (65 kg), flax fiber (20 kg), non-toxic calcium-zinc complex stabilizer (5 kg), AC foaming agent (5 kg), and stearic acid (5 kg) were mixed. The resulting blend was charged into an extruder and extruded at 140° C. to produce an extrudate, which was cooled and surface-treated to provide a decking board.

### EXAMPLE 4

PVC resin (80 kg), flax fiber (5 kg), non-toxic calcium-zinc complex stabilizer (5 kg), AC foaming agent (3 kg), a polyacrylate copolymer processing aid (Zibo Huaxing Additives Co., Ltd., Zigo, Shandong, China; Catalog Number: ZB530; 5.5 kg), PE wax (0.3 kg), and stearic acid (0.2 kg) were mixed. The resulting blend was charged into an extruder and extruded at 190° C. to produce an extrudate, which was cooled and surface-treated to provide a decking board.

Variations, modifications, and other implementations of what is described herein will occur to those of ordinary skill in the art without departing from the spirit and the essential characteristics of the present teachings. Accordingly, the scope of the invention is to be defined not by the preceding illustrative description but instead by the following claims, and all changes that come within the meaning and range of equivalency of the claims are intended to be embraced herein.

1. A composition comprising an un-plasticized polyvinylchloride and a flax fiber.

2. The composition of claim 1, wherein the un-plasticized polyvinylchloride is in the amount between about 60 wt % and about 85 wt %.

3. The composition of claim 1, wherein the flax fiber is in the amount between about 2 wt % and about 50 wt %.

4. The composition of claim 1, where the flax fiber is in the amount between about 5 wt % and about 20 wt %.

5. The composition of claim 1, further comprising a stabilizer.

6. The composition of claim 5, wherein the stabilizer is a calcium-zinc complex stabilizer.

7. The composition of claim 5, wherein the stabilizer is in the amount between about 2 wt % and about 6 wt %.

8. The composition of claim 1, further comprising a processing aid, a lubricant, or a combination thereof.

9. The composition of claim 8, wherein the processing aid or the lubricant is selected from a polyacrylate copolymer processing aid, a polyethylene wax, a stearate ester, and a stearic acid.

10. The composition of claim 8, wherein each of the processing aid and the lubricant is in the amount between about 2 wt % and about 6 wt %.

11. The composition of claim 1, wherein the composition is a blend.

12. The composition of claim 11, wherein the blend comprises a foaming agent.

13. The composition of claim 12, wherein the foaming agent is an azodicarbonamide foaming agent.

14. The composition of claim 12, wherein the foaming agent is in the amount between about 2 wt % and about 6 wt %.

15. A method of making a fiber-reinforced U-PVC material, the method comprising mixing an un-plasticized polyvinylchloride and a flax fiber to provide a blend; and extruding the blend at an elevated temperature to provide the composition of claim 1.

16. The method of claim 15, further comprising mixing at least one of a stabilizer, a foaming agent, a processing aid, and a lubricant with the polyvinylchloride and the flax fiber.

17. The method of claim 15, wherein the elevated temperature is between about 100° C. and about 200° C.

18. A composite comprising the composition of claim 1.

19. An article of manufacture comprising the composition of claim 1.

20. The article of manufacture of claim 19, wherein the article of manufacture comprises a fence, a decking board, a shingle, a window frame, a door frame, a railing, a post, a lattice, or a picket.
